(19) United States
(12) Patent Application Publication
(10) Pub. No.: US 2014/0192609 A1
(43) Pub. Date: Jul. 10, 2014

(54) VIBRATION GENERATING DEVICE

(71) Applicant: Wistron Corporation, New Taipei City (TW)

(72) Inventors: Chiang Chi-Chan, New Taipei City (TW); Chih-Kuan Lin, New Taipei City (TW)

(73) Assignee: Wistron Corporation, New Taipei City (TW)

(21) Appl. No.: 14/061,792

(22) Filed: Oct. 24, 2013

(30) Foreign Application Priority Data
Jan. 7, 2013 (TW) 102100370

(51) Int. Cl. B01F 11/02

(52) U.S. Cl. CPC B01F 11/02
USPC 366/111

(57) ABSTRACT

A vibration generating device including a working platform, an opposite platform and a driving unit is provided. The working platform carries a workpiece disposed on one side of the working platform. The opposite platform is adjacent to another side of the working platform. The working platform and the opposite platform contact to each other via at least two bumps reversely protruded between the working platform and the opposite platform. The driving unit is coupled to the working platform or the opposite platform to drive the working platform or the opposite platform to move in a horizontal direction, and the working platform generates a vibration in a vertical direction.

This application claims the benefit of Taiwan application Serial No. 102100370, filed Jan. 7, 2013, the subject matter of which is incorporated herein by reference.

### BACKGROUND OF THE INVENTION

1. Field of the Invention

The invention relates in general to a vibration generating device, and more particularly to a vibration generating device with horizontal movement and vertical vibration.

2. Description of the Related Art

Conventional vibration generating device uses a vibration motor to transmit vibration energy to a workpiece. For example, a test tube containing a test sample is placed on a susceptor, and the vibration motor operates at a high speed such that the susceptor generates a vibration. The particles inside the test sample are vibrated and scattered in the test tube to achieve a stirring effect. However, the position of the vibration motor will affect the effect of vibration. For example, the place farther away from the vibration motor has inferior effect of vibration, and the problem of uneven vibration may occur.

The stirring effect can also be achieved by using a straw to repeatedly absorb the test sample, such that the particles inside the test sample are scattered in the test tube. However, the contact type stirring manner, having the problems of contact pollution and additional cost for cleaning/sterilizing the straw, is not suitable for large number of test samples and needs further improvements.

### SUMMARY OF THE INVENTION

The invention is directed to a vibration generating device capable of moving in a horizontal direction and generating a vibration in a vertical direction.

According to one embodiment of the present invention, a vibration generating device including a working platform, an opposite platform and a driving unit is provided. The working platform carries a workpiece disposed on one side of the working platform. The opposite platform is adjacent to another side of the working platform. The working platform and the opposite platform contact to each other via at least two bumps reversely protruded between the working platform and the opposite platform. The driving unit is coupled to the working platform or the opposite platform to drive the working platform or the opposite platform to move in a horizontal direction, and the working platform generates a vibration in a vertical direction.

According to another embodiment of the present invention, a vibration generating device including a working platform, an opposite platform and a driving unit is provided. The working platform carries a workpiece disposed on one side of the working platform. The opposite platform is adjacent to another side of the working platform. The working platform and the opposite platform contact to each other via at least two bumps reversely protruded between the working platform and the opposite platform. The driving unit is coupled to the working platform and/or the opposite platform to drive the working platform and/or the opposite platform to move on a 2D plane, and the working platform generates a vibration in a vertical direction.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of a test sample in a susceptor.

FIGS. 2A and 2B respectively are schematic diagrams of a vibration generating device according to an embodiment of the invention.

FIGS. 3A-3C are diagrams of the shape and arrangement of bumps.

FIGS. 4A-4C are diagrams of the shape and arrangement of bumps.

FIG. 5 is a schematic diagram of a vibration generating device according to an embodiment of the invention.

FIGS. 6A-6E are schematic diagrams of various implementations of a vibration generating device.

### DETAILED DESCRIPTION OF THE INVENTION

Through the use of simple structure of a horizontal transmission mechanism, the vibration generating device of the invention enables two platforms to generate one-way or two-way movement. Furthermore, the two platforms contact to each other via bumps reversely protruded between the two platforms can generate a jumping effect similar to the vehicle passing through the bumpy road. That is, when a platform and an opposite platform move relatively to each other, the platform passing through the bumps jumps up and down due to the height difference between the bumps. Thus, the frequency and amplitude of vibration can be controlled to generate a wobbling effect on a workpiece disposed on the platform through the arrangement of the quantity, height and interval of the bumps through which the platform passes or the adjustment of the speed and shifted distance of the platform.

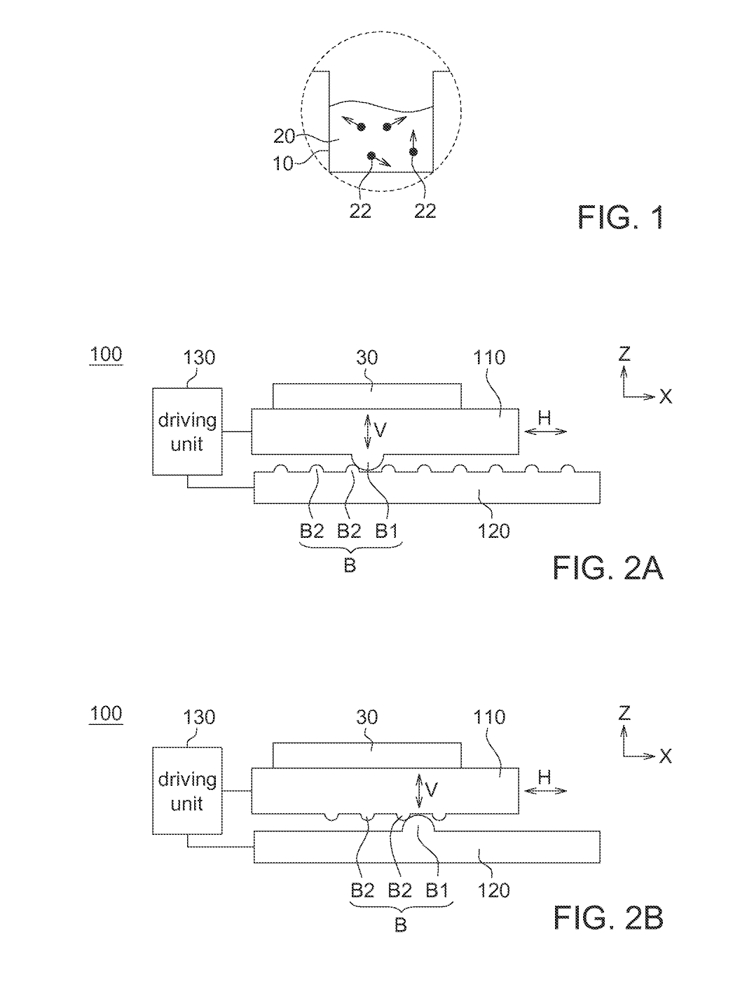

The workpiece according to the present embodiment has a plurality of tubes on which a test sample is placed. Referring to FIG. 1, a schematic diagram of a test sample in a tube is shown. Through the use of the vibration generating device of the invention, the particles 22 of the test sample 20 can be uniformly distributed in the tube 10 after having been shaken left and right as well as up and down to avoid the problems associated with the conventional contact type stirring manner. The vibration generating device of the invention can be used in large number of tests to reduce the testing cost.

A number of embodiments are disclosed below for elaborating the invention. However, the embodiments of the invention are for detailed descriptions only, not for limiting the scope of protection of the invention. In the embodiments disclosed below, the so called ‘horizontal direction’ refers to such as the X-axis direction, the Y-axis direction or a particular direction, and the so called ‘horizontal movement’ refers to any types of movement on a 2D plane (such as the X-Y plane), and is not limited to the movement in the X-axis direction and/or the Y-axis direction. The so called ‘vertical direction’ refers to a direction (such as the Z-axis direction) substantially perpendicular to the 2D plane.

### First Embodiment

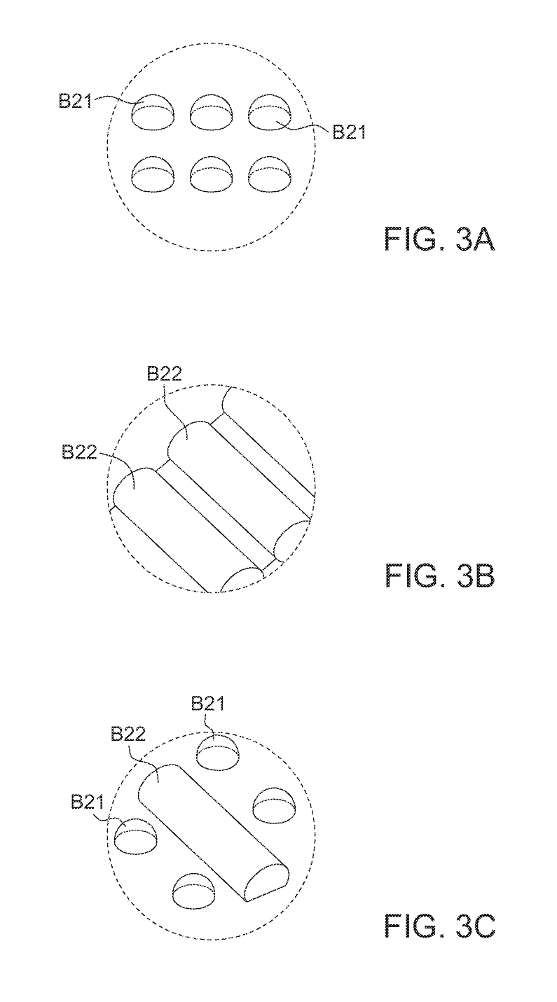

Referring to FIGS. 2A and 2B, schematic diagrams of a vibration generating device 100 according to an embodiment of the invention are respectively shown. The vibration generating device 100 comprises a working platform 110, an opposite platform 120 and a driving unit 130. The working platform 110 carries a workpiece 30 disposed on one side of the working platform 110. The opposite platform 120 is adjacent to another side of the working platform 110. The working platform 110 and the opposite platform 120 contact to each other via at least two bumps B1 and B2 reversely protruded between the working platform 110 and the opposite platform 120.

As indicated in FIG. 2A, the working platform 110 is disposed above the opposite platform 120 and is retained with a damper (not illustrated) such that the working platform 110 can stably move on the opposite platform 120 in a horizontal direction. At least one first bump B1 is disposed on one side of the working platform 110, and a plurality of second bumps B2 are disposed on one side of the opposite platform 120 close to the working platform 110, such that the first bump B1, when moving along the horizontal direction H, sequentially contacts a plurality of second bumps B2 and generates a jumping effect.

As indicated in FIG. 2B, the working platform 110 is disposed above the opposite platform 120. FIG. 2B is different from FIG. 2A in that at least one first bump B1 is disposed on one side of the opposite platform 120, and a plurality of second bumps B2 are disposed on the side of the working platform 110 close to the opposite platform 120. Similarly, the second bumps B2, when moving along the horizontal direction H, sequentially contact the first bump B1 and generates a jumping effect.

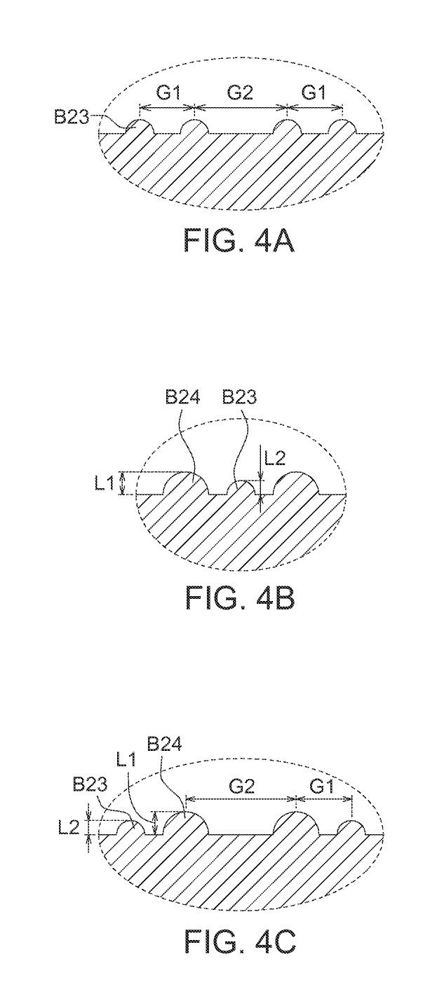

The first bump B1 and the second bumps B2 can be bar-shaped bumps B22, semi-circular bumps B21 or a combination thereof. Referring to FIG. 3A, the bumps, such as the semi-circular bumps B21, are arranged in the form of a matrix having several columns and rows along the horizontal direction H. Referring to FIG. 3B, the bumps, such as the bar-shaped bumps B22, are arranged along the horizontal direction H. Referring to FIG. 3C, the bumps, such as a combination of bar-shaped bumps B22 and semi-circular bumps B21, are staggered with each other along the horizontal direction H. Although the present embodiment is exemplified by the bar-shaped bumps B22 and the semi-circular bumps B21, the shape of the bumps is not limited to the above exemplifications, and other shapes such as diamond-shape, cone, trapezoid or semi-ellipse would also do.

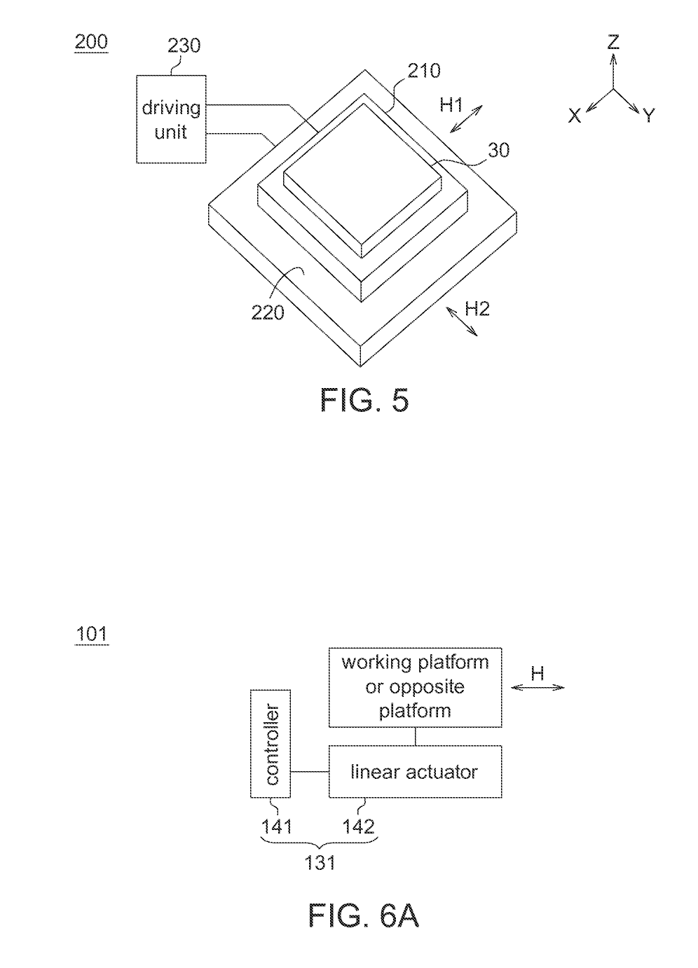

Referring to FIGS. 4A˜4C, diagrams of the shape and arrangement of bumps are shown. In addition to the equal height and equal interval arrangement on the working platform 110 or the opposite platform 120 as indicated in FIGS. 2A and 2B, the height and/or interval of the bumps B can be adjusted to generate different vibration effects. As indicated in FIG. 4A, a plurality of second bumps B23 are arranged at an equal height but unequal intervals along the horizontal direction H. When the first bump B1 passes through the second bumps B23 arranged at an interval G1, the frequency of vibration will increase accordingly. When the first bump B1 passes through the second bumps B23 arranged at an interval G2 (G2>G1), the frequency of vibration will decrease accordingly. Therefore, the frequency of vibration can be changed by adjusting the interval of the second bumps B23. As indicated in FIG. 4B, a plurality of second bumps B23 and B24 are arranged at an equal interval but unequal heights along the horizontal direction H. When the first bump B1 passes through the second bumps B24 arranged at a height L1, the amplitude of vibration will increase accordingly. When the first bump B1 passes through the second bumps B23 arranged at a height L2 (L1>L2), the amplitude of vibration will decrease accordingly. Therefore, the amplitude of vibration can be changed by adjusting the height of the second bumps B23 and B24. As indicated in FIG. 4C, a plurality of second bumps B23 and B24 are arranged at unequal intervals and unequal heights along the horizontal direction H. When the first bump B1 passes through the second bumps B23 and B24 having unequal heights (L1>L2), the amplitude of vibration will change accordingly (the amplitude of vibration is proportional to the height of the bumps). When the first bump B1 passes the second bumps B23 and B24 arranged at different intervals (G2>G1), the frequency of vibration will change accordingly (the frequency of vibration is inversely proportional to the interval of the bumps). Therefore, the amplitude and frequency of vibration can be changed respectively by adjusting the height and interval of the second bumps B23 and B24.

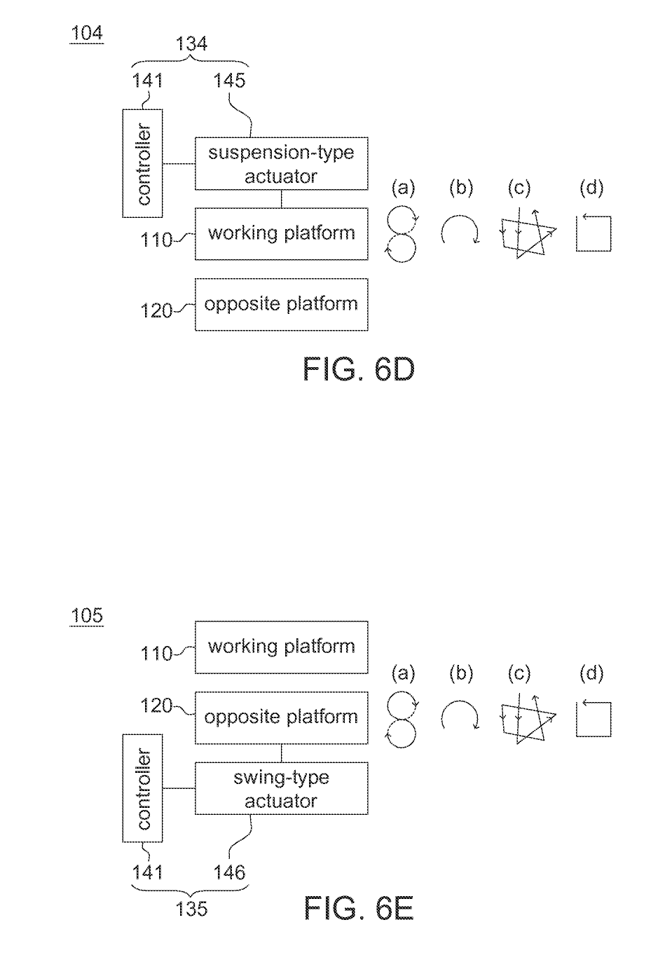

The driving unit according to the present embodiment comprises at least one linear actuator. The linear actuator is a device transmitting power through a guide screw or a conveyor belt to drive the working platform 110 or the opposite platform 120, such that the working platform 110 or the opposite platform 120 can move in a horizontal direction H. Referring to the vibration generating device 101 of FIG. 6A, the driving unit 131 comprises a controller 141 and a linear actuator 142. The linear actuator 142 is coupled to the working platform 110 or the opposite platform 120. The controller 141, according to the driving signal, controls the linear actuator 142 to transmit power along the horizontal direction H. Alternatively, referring to the vibration generating device 102 of FIG. 6B, the driving unit 132 comprises a controller 141, a first actuator 143 and a second actuator 144. The first actuator 143 and the second actuator 144 are coupled to the working platform 110 or the opposite platform 120. The controller 141, according to the driving signal, controls the first actuator 143 to transmit power along the first horizontal direction H1 or controls the second actuator 144 to transmit power along the second horizontal direction H2.

Thus, through the movement of the working platform 110 or the opposite platform 120 in a horizontal direction H and the jumping effect generated when the first bump B1 passes through the second bumps B2, the working platform 110 can generate vibration in a vertical direction V such that the workpiece 30 disposed on the working platform 110 vibrates and generates a wobbling effect.

### Second Embodiment

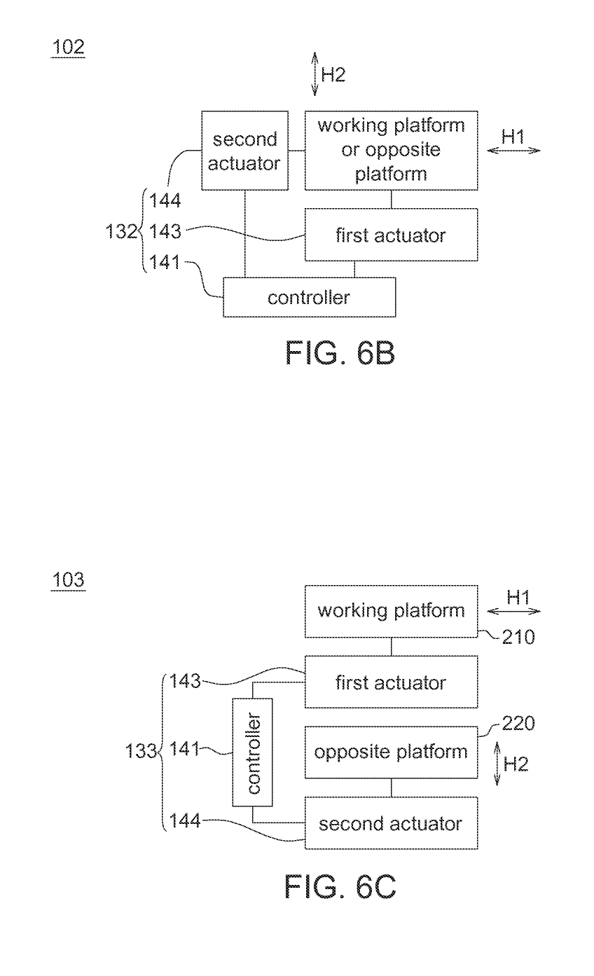

Referring to FIG. 5, a schematic diagram of a vibration generating device 200 according to an embodiment of the invention is shown. The vibration generating device 200 comprises a working platform 210, an opposite platform 220 and a driving unit 230. The disposition of the working platform 210, the opposite platform 220, and a plurality of bumps contacting to each other and disposed between the working platform 210 and the opposite platform 220 (not illustrated) of the present embodiment is similar to the disposition of the first embodiment. Detailed descriptions of the disposition of the present embodiment can be obtained by reference to FIGS. 2A-2B, 3A-3C and 4A-4C and the descriptions thereof, and are not repeated here.

The present embodiment is different from the first embodiment in that: the driving unit 230 is coupled to the working platform 210 and the opposite platform 220 to drive the working platform 210 and the opposite platform 220 to generate a relative movement on a 2D plane. As indicated in the vibration generating device 103 of FIG. 6C, the driving unit 133 comprises a controller 141, a first actuator 143 and a second actuator 144. The first actuator 143 is coupled to the working platform 210. The second actuator 144 is coupled to the opposite platform 220. The controller 141, according to the driving signal, controls the first actuator 143 to transmit power along the first horizontal direction H1 so as to drive the working platform 210 and controls the second actuator 144 to transmit power along the second horizontal direction H2 so as to drive the opposite platform 220.

Through the movement of the working platform 210 and the opposite platform 220 in two horizontal directions H1 and H2 and the vibration generated by the working platform 110 in a vertical direction V, a workpiece 30 disposed on the working platform 110 vibrates and generates a wobbling effect.

### Third Embodiment

Referring to the two embodiments of FIGS. 6D and 6E. Apart from using the linear actuator 142 of FIG. 6A to drive the working platform 110 or the opposite platform 120, the driving unit may use a non-linear actuator (such as a suspension-type actuator or a swing-type actuator) to drive the working platform 110 or the opposite platform 120, such that the working platform 110 or the opposite platform 120 can generate a horizontal movement.

Referring to the vibration generating device 104 of FIG. 6D. The driving unit 134 comprises a controller 141 and a suspension-type actuator 145. The suspension-type actuator 145 carries the working platform 110 stably placed on the opposite platform 120 and further drives the working platform 110 to generate a horizontal movement opposite to the opposite platform 120. The horizontal movement is an S-shaped or 8-shaped movement shown in (a) of FIG. 6D, a circular movement shown in (b) of FIG. 6D, an irregular movement shown in (c) of FIG. 6D or a rectangular movement shown in (d) of FIG. 6D.

Referring to the vibration generating device 105 of FIG. 6E. The driving unit 135 comprises a controller 141 and a swing-type actuator 146. The swing-type actuator 146 carries the opposite platform 120. The working platform 110 is fixed by a damper (not illustrated) and stably placed on the opposite platform 120. The swing-type actuator 146 drives the opposite platform 120 to generate a horizontal movement opposite to the working platform 110. The horizontal movement is an S-shaped or 8-shaped movement shown in (a) of FIG. 6E, a circular movement shown in (b) of FIG. 6E, an irregular movement shown in (c) of FIG. 6E or a rectangular movement shown in (d) of FIG. 6E. The horizontal movement exemplified above is not limited to any types of implementations, and any types of horizontal movement would do.

Therefore, a workpiece 30 disposed on the working platform 110 vibrates and generates a wobbling effect through the design of the movement, that is, the design of moving the working platform 110 or the opposite platform 120 on a 2D plane and vibrating the working platform 110 in a vertical direction V.

Through the use of simple structure of a horizontal transmission mechanism, the vibration generating device according to the above embodiments of the invention enables two platforms to generate horizontal movement and vertical vibration to generate jumping effect similar to the vehicle passing through the bumpy road, hence avoiding the non-uniform or one-way vibration caused by the use of vibration motor.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A vibration generating device comprising:
a working platform carrying a workpiece disposed on one side of the working platform;
an opposite platform adjacent to another side of the working platform, wherein the working platform and the opposite platform contact to each other via at least two bumps reversely protruded between the working platform and the opposite platform; and
a driving unit coupled to the working platform or the opposite platform to drive the working platform or the opposite platform to move in a horizontal direction, wherein the working platform generates a vibration in a vertical direction.

2. The vibration generating device according to claim 1, wherein at least one first bump is disposed on one of the working platform and the opposite platform, and a plurality of second bumps are disposed on the other one of the working platform and the opposite platform.

3. The vibration generating device according to claim 2, wherein the second bumps are arranged at an equal or unequal interval along the horizontal direction.

4. The vibration generating device according to claim 2 wherein the second bumps are arranged at an equal or unequal height along the horizontal direction.

5. The vibration generating device according to claim 3, wherein an interval of the second bumps is inversely proportional to a frequency of the vibration in the vertical direction.

6. The vibration generating device according to claim 4, wherein a height of the second bumps is proportional to an amplitude of the vibration in the vertical direction.

7. The vibration generating device according to claim 2, wherein the second bumps are bar-shaped bumps, semi-circular bumps or a combination thereof.

8. The vibration generating device according to claim 1, wherein the driving unit comprises a linear actuator which transmits power along the horizontal direction.

9. The vibration generating device according to claim 1, wherein the driving unit comprises a first actuator which transmits power along a first horizontal direction and a second actuator which transmits power along a second horizontal direction.

10. A vibration generating device, comprising:
a working platform carrying a workpiece disposed on one side of the working platform;
an opposite platform adjacent to another side of the working platform, wherein the working platform and the opposite platform contact to each other via at least two bumps reversely protruded between the working platform and the opposite platform; and
a driving unit coupled to the working platform and/or the opposite platform to drive the working platform and/or the opposite platform to move on a 2D plane, and the working platform generates a vibration in a vertical direction.

11. The vibration generating device according to claim 10, wherein at least one first bump is disposed on one of the working platform and the opposite platform, and a plurality of second bumps are disposed on the other one of the working platform and the opposite platform,

12. The vibration generating device according to claim 11, wherein the second bumps arranged at an equal or unequal interval along a direction parallel to the 2D plane.

13. The vibration generating device according to claim 11, wherein the second bumps arranged at an equal or unequal height along the direction parallel to the 2D plane.

14. The vibration generating device according to claim 12, wherein an interval of the second bumps is inversely proportional to a frequency of the vibration in the vertical direction.

15. The vibration generating device according to claim 13, wherein a height of the second bumps is proportional to an amplitude of the vibration in the vertical direction.

16. The vibration generating device according to claim 11, wherein the second bumps are bar-shaped bumps, semi-circular bumps or a combination thereof.

17. The vibration generating device according to claim 10, wherein the driving unit comprises a first actuator which transmits power along a first horizontal direction parallel to the 2D plane and a second actuator which transmits power along a second horizontal direction parallel to the 2D plane.

18. The vibration generating device according to claim 10, wherein the driving unit comprises a suspension-type actuator carrying the working platform and enabling the working platform to move in a horizontal direction parallel to the 2D plane with respect to the opposite platform.

19. The vibration generating device according to claim 10, wherein the driving unit comprises a swing-type actuator carrying the opposite platform and enabling the opposite platform to move in a horizontal direction parallel to the 2D plane with respect to the working platform.
